(19) United States
(12) Patent Application Publication
(10) Pub. No.: US 2005/0271883 A1
(43) Pub. Date: Dec. 8, 2005

(54) Light-transmitting element and method for making same

(75) Inventors: Charles Leu, Fremont, CA (US); Ching-Yen Lee, Tu-Cheng (TW); Tai-Cheng Yu, Tu-Cheng (TW); Jhy-Chain Lin, Tu-Cheng (TW); Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/046,954

(22) Filed: Jan. 31, 2005

(30) Foreign Application Priority Data
Jun. 3, 2004 (CN) 200410026475.4

(51) Int. Cl. B05D 5/06; B32B 9/00; B32B 27/40; G02F 1/1333

(52) U.S. Cl. 428/424.2; 427/162; 428/702; 428/446; 428/336

(57) ABSTRACT

A light-transmitting element (10) includes a substrate (12) made of polymethyl methacrylate, and at least one coating film (14). The substrate has a first surface (122), and a second surface (124) opposite to the first surface. The coating film is deposited on at least one of the surfaces of the substrate by electron beam evaporation. The coating film is selected from the group consisting of a single layer and a plurality of layers, and comprises a material selected from the group consisting of tantalum pentoxide, magnesium fluoride, silicon oxide, and any mixture or combination thereof. The light-transmitting element provides improved light transmittance for an imaging system. A method for making the light-transmitting element is also provided.

### BACKGROUND OF THE INVENTION

1. Field of the Invention

The present invention relates to passive light-transmitting elements and methods for making the same, and particularly to a light-transmitting element for an imaging system and a method for making the light-transmitting element.

2. Related Art

With the ongoing development of optical technology, light-transmitting elements are now in widespread use in a variety of applications. Polymethyl methacrylate (PMMA) is a transparent thermoplastic resin which has a visible light transmittance higher than that of glass, excellent optical properties, and low birefringence. Therefore PMMA has long been used as a material for a wide variety of optical products such as optical lenses and optical discs.

In recent years, there has been an increasing demand for PMMA to be used as a light-transmitting element for the plastic lens of imaging systems. The light-transmitting element for the lens functions to propagate and diffuse light that enters from a certain direction, such that the light exits in the direction of imaging.

In a typical imaging system, the light-transmitting element is a light-transmitting plate. If the distance traveled by light through the light-transmitting plate is relatively long, the amount of light lost in the light-transmitting plate is correspondingly high. For preventing or minimizing loss of light, the material of the light-transmitting plate is required to have a high light transmittance. Thus PMMA has been routinely employed for use in light-transmitting plates.

However, a light-transmitting element made of PMMA still has relatively high light reflection at interfaces thereof. This reduces the overall light transmittance of the light-transmitting element. Even when a light-transmitting element is configured to be optically optimized, the light transmittance is generally only in a range up to 92 percent. That is, at least 8 percent of light is reflected. Thus the resolution of the image obtained in the imaging system is decreased, and the quality of the obtained image may not be satisfactory.

Therefore, a light-transmitting element and a method for making the light-transmitting element which overcome the above-described problems are desired.

### SUMMARY OF THE INVENTION

An object of the present invention is to provide a light-transmitting element for an imaging system which has a high light transmittance.

Another object of the present invention is to provide a method for making a light-transmitting element for an imaging system which has a high light transmittance.

To achieve the first of the above objects, a light-transmitting element for imaging system includes a substrate made of polymethyl methacrylate, and at least one coating film. The substrate has a first surface, and a second surface opposite to the first surface. The coating is formed on at least one surface of the substrate. The coating film is selected from the group consisting of a single layer and a plurality of layers, and comprises a material selected from the group consisting of tantalum pentoxide, magnesium fluoride, silicon oxide, and any mixture or combination thereof.

To achieve the second of the above objects, a method for forming a light-transmitting element comprises the steps of: providing a substrate made of polymethyl methacrylate, the substrate having a first surface and a second surface opposite to the first surface; and depositing at least one coating film on at least one surface of the substrate. The coating film is selected from the group consisting of a single layer and a plurality of layers, and comprises a material selected from the group consisting of tantalum pentoxide, magnesium fluoride, silicon oxide, and any mixture or combination thereof.

A main advantage of the invention is that the light transmittance of the light-transmitting element is improved. Accordingly, the quality of images obtained by the imaging system is enhanced.

Other objects, advantages and novel features of the invention will become more apparent from the following detailed description when taken in conjunction with the accompanying drawings, in which:

### BRIEF DESCRIPTION OF THE DRAWINGS

FIG. 1 is a schematic, side cross-sectional view of part of a light-transmitting element in accordance with a first preferred embodiment of the present invention;

FIG. 2 is a schematic, side cross-sectional view of a light-transmitting element in accordance with a second preferred embodiment of the present invention; and

FIG. 3 a schematic, side cross-sectional view of a light-transmitting element in accordance with a third preferred embodiment of the present invention.

### DETAILED DESCRIPTION OF THE INVENTION

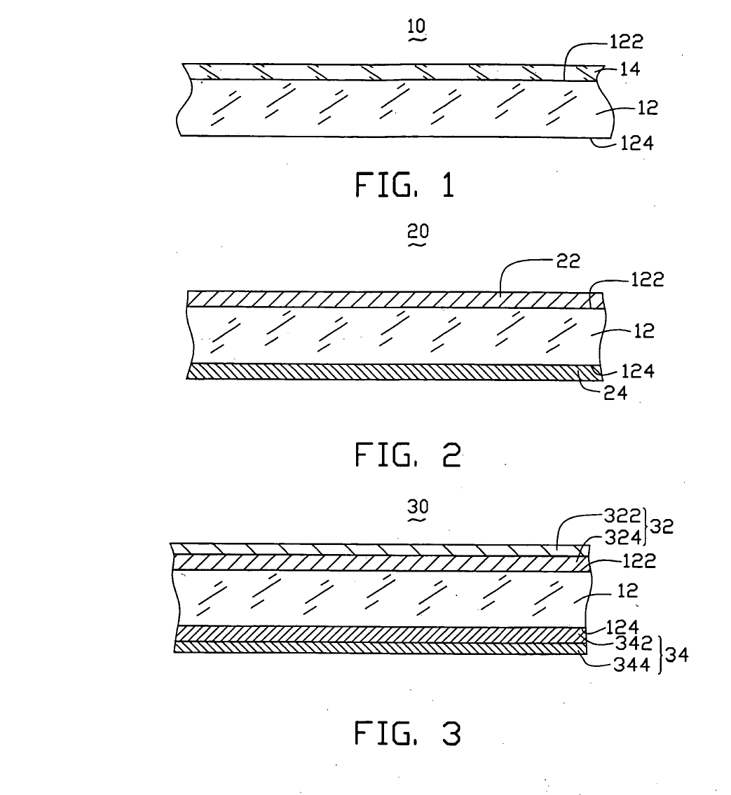

FIG. 1 shows a light-transmitting element 10 according to the first preferred embodiment of the present invention. The light-transmitting element 10 is used in an imaging system, and may for example function as a plastic lens. The light-transmitting element 10 comprises a substrate 12 and a coating film 14. The substrate 12 has a first surface 122, and a second surface 124 opposite to the first surface 122. The coating film 14 is deposited on the first surface 122 of the substrate 12.

The substrate 12 is made of polymethyl methacrylate (PMMA) and has a thickness of 0.85 mm. The coating film 14 is made of silicon oxide (SiO₂), and has a thickness of 67.22 nm.

A method for making the light-transmitting element 10 comprises the steps of: providing a substrate 12 made of PMMA having a first surface 122 and a second surface 124 opposite to the first surface 122; and depositing a coating film 14 made of SiO₂ on the first surface 122 of the substrate 12 by electron beam evaporation.

The coating film 14 can also be deposited on the substrate 12 in any conventional manner, such as by way of (but not limited to) magnetron sputter vapor deposition (MSVD), chemical vapor deposition (CVD), spray pyrolysis (i.e., pyrolytic deposition), atmospheric pressure CVD (APCVD), low-pressure CVD (LPCVD), plasma-enhanced CVD (PEVCD), plasma assisted CVD (PACVD), thermal or electron-beam evaporation, cathodic arc deposition, plasma spray deposition, and wet chemical deposition (e.g., sol-gel, mirror silvering etc.). It is noted that sputter deposited coatings are perceived by some to be less mechanically durable than coatings deposited by spray pyrolysis or CVD-type coating methods. Examples of suitable CVD coating apparatuses and methods are found, for example (but not limiting the present invention to), in U.S. Pat. Nos. 3,652,246, 4,351,861, 4,719,126, 4,853,257, 5,356,718 and 5,776,236.

When external light enters the coating film 14 of the light-transmitting element 10, travels through the substrate 12, and exits from the second surface 124, the light transmittance of the light-transmitting element 10 is increased. The average light transmittance of the light-transmitting element 10 at light wavelengths of 800 nm, 750 nm, and 350 nm can be seen from the following table 1:

TABLE 1

| Light wavelength (nm) | Average light transmittance % |
|---|---|
| 800 | 93.05 |
| 750 | 93.08 |
| 550 | 93.18 |
| 350 | 92.94 |

FIG. 2 shows a light-transmitting element 20 according to the second preferred embodiment of the present invention. The light-transmitting element 20 comprises a substrate 12 made of PMMA, a coating film 22 deposited on a first surface 122 of the substrate 22, and a coating film 24 deposited on a second surface 124 of the substrate 12. The substrate 12 has a thickness of 0.85 mm. The coating films 22, 24 are made of SiO₂, and each has a thickness of 59.44 nm. Deposition of the coating films 22, 24 can be performed in the same manner as described above in relation to the coating film 14 of the first embodiment.

When external light enters the coating film 22 of the light-transmitting element 20, travels through the substrate 12, and exits from the second surface 124 in the direction of the coating film 24, the light transmittance of the light-transmitting element 20 is increased. The average light transmittance of the light-transmitting element 20 at light wavelengths of 800 nm, 750 nm, 550 nm and 350 nm can be seen from the following table 2:

TABLE 2

| Light wavelength (nm) | Average light transmittance % |
|---|---|
| 800 | 93.37 |
| 750 | 93.43 |
| 550 | 93.65 |
| 350 | 93.38 |

In alternative embodiments, a material with a special refractive index and/or a thickness of the coating film 22 and/or the coating film 24 can be varied according to particular requirements. The average light transmittance of various different embodiments of the light-transmitting element 10 at light wavelengths of 800 nm, 750 nm, 550 nm and 350 nm can be seen from the following tables 3 through 6:

TABLE 3

| Film material/thickness (nm) | | Light wavelength | Average light |
|---|---|---|---|
| Film 22 | Film 24 | (nm) | transmittance % |
| MgF₂/88.33 | MgF₂/88.29 | 800 | 95.52 |
| MgF₂/88.33 | MgF₂/88.29 | 750 | 95.79 |
| MgF₂/88.33 | MgF₂/88.29 | 550 | 96.91 |
| MgF₂/88.33 | MgF₂/88.29 | 350 | 95.50 |

TABLE 4

| Film material/thickness (nm) | | Light wavelength | Average light |
|---|---|---|---|
| Film 22 | Film 24 | (nm) | transmittance % |
| MgF₂/62.67 | MgF₂/67.52 | 800 | 94.39 |
| MgF₂/62.67 | MgF₂/67.52 | 750 | 94.60 |
| MgF₂/62.67 | MgF₂/67.52 | 550 | 95.80 |
| MgF₂/62.67 | MgF₂/67.52 | 350 | 97.04 |

TABLE 5

| Film material/thickness (nm) | | Light wavelength | Average light |
|---|---|---|---|
| Film 22 | Film 24 | (nm) | transmittance % |
| SiO₂/63.65 | MgF₂/67.52 | 800 | 93.99 |
| SiO₂/63.65 | MgF₂/67.52 | 750 | 94.13 |
| SiO₂/63.65 | MgF₂/67.52 | 550 | 94.84 |
| SiO₂/63.65 | MgF₂/67.52 | 350 | 95.15 |

TABLE 6

| Film material/thickness (nm) | | Light wavelength | Average light |
|---|---|---|---|
| Film 22 | Film 24 | (nm) | transmittance % |
| SiO₂/59.40 | MgF₂/67.52 | 800 | 93.94 |
| SiO₂/59.40 | MgF₂/67.52 | 750 | 94.08 |
| SiO₂/59.40 | MgF₂/67.52 | 550 | 94.79 |
| SiO₂/59.40 | MgF₂/67.52 | 350 | 95.16 |

FIG. 3 shows a light-transmitting element 30 according to the third preferred embodiment of the present invention. The light-transmitting element 30 comprises a substrate 12 made of PMMA, a first hybrid coating film 32 deposited on a first surface 122 of the substrate 12, and a second hybrid coating film 34 deposited on a second surface 124 of the substrate 12. The substrate 12 has a thickness of 0.85 mm. The first hybrid coating film 32 comprises a first outer layer 322 made of tantalum pentoxide (Ta₂O₅), and a first inner layer 324 made of magnesium fluoride (MgF₂). The first outer layer 322 has a thickness of 4.16 nm. The first inner layer 324 has a thickness of 94.60 nm. The second hybrid coating film 34 comprises a second inner layer 342 made of SiO₂, and a second outer layer 344 made of MgF₂. The second inner layer 342 has a thickness of 83.83 nm. The second outer layer 344 has a thickness of 77.36 nm.

A method for making the light-transmitting element 30 comprises the steps of: providing the substrate 12 made of PMMA having the first surface 122 and the second surface 124 opposite to the first surface 122; depositing the first inner layer 324 on the first surface 122 of the substrate 12; depositing the first outer layer 322 on the first inner layer 324 of the substrate 12 by electron beam evaporation; depositing the second inner layer 342 on the second surface 124 of the substrate 12 by electron beam evaporation; and depositing the second outer layer 344 on the second inner layer 342 of the substrate 12 by electron beam evaporation.

When external light enters the first hybrid coating film 32 of the light-transmitting element 30, travels through the substrate 12, and exits from the second surface 124 in the direction of the second hybrid coating film 34, the light transmittance of the light-transmitting element 30 is increased. The average light transmittance of the light-transmitting element 30 at light wavelengths of 800 nm, 750 nm, 550 nm and 350 nm can be seen from the following table 7:

TABLE 7

| Light wavelength (nm) | Average light transmittance % |
|---|---|
| 800 | 95.32 |
| 750 | 95.46 |
| 550 | 96.44 |
| 350 | 97.22 |

In alternative embodiments, a material and/or a thickness of the first hybrid coating film 32 and/or the second hybrid coating film 34 can be varied according to particular requirements. For instance, the first outer layer 322 is made of SiO₂, and has a thickness of 8.52 nm. The first inner layer 324 is made of MgF₂, and has a thickness of 69.56 nm. The second inner layer 342 is made of SiO₂, and has a thickness of 8.55 nm. The second outer layer 344 is made of MgF₂, and has a thickness of 69.19 nm. The average light transmittance of the above-described alternative embodiment of the light-transmitting element 30 at light wavelengths of 800 nm, 750 nm, 550 nm and 350 nm can be seen from the following table 8:

TABLE 8

| Light wavelength (nm) | Average light transmittance % |
|---|---|
| 800 | 94.79 |
| 750 | 95.02 |
| 550 | 96.23 |
| 350 | 96.88 |

In a further alternative embodiment, the first outer layer 322 is made of Ta₂O₅, and has a thickness of 5.59 nm. The first inner layer 324 is made of MgF₂, and has a thickness of 90.46 nm. The second inner layer 342 is made of SiO₂, and has a thickness of 57.69 nm. The second outer layer 344 is made of MgF₂, and has a thickness of 91.36 nm. The average light transmittance of the above-described further alternative embodiment of the light-transmitting element 30 at light wavelengths of 800 nm, 750 nm, 550 nm and 350 nm can be seen from the following table 9:

TABLE 9

| Light wavelength (nm) | Average light transmittance % |
|---|---|
| 800 | 95.06 |
| 750 | 95.23 |
| 550 | 96.21 |
| 350 | 97.12 |

In a still further alternative embodiment, the first outer layer 322 is made of SiO₂, and has a thickness of 53.08 nm. The first inner layer 324 is made of Ta₂O₅, and has a thickness of 4.14 nm. The second inner layer 342 is made of SiO₂, and has a thickness of 37.73 nm. The second outer layer 344 is made of MgF₂, and has a thickness of 72.31 nm. The average light transmittance of the above-described still further alternative embodiment of the light-transmitting element 30 at light wavelengths of 800 nm, 750 nm, 550 nm and 350 nm can be seen from the following table 10:

TABLE 10

| Light wavelength (nm) | Average light transmittance % |
|---|---|
| 800 | 95.34 |
| 750 | 95.50 |
| 550 | 96.29 |
| 350 | 97.30 |

In a yet further alternative embodiment, the first outer layer 322 is made of SiO₂, and has a thickness of 51.00 nm. The first inner layer 324 is made of Ta₂O₅, and has a thickness of 3.20 nm. The second inner layer 342 is made of Ta₂O₅, and has a thickness of 3.21 nm. The second outer layer 344 is made of MgF₂, and has a thickness of 97.14 nm. In addition, the first hybrid coating film 32 further includes an innermost layer, which is made of MgF₂ and has a thickness of 56.19 nm. The second hybrid coating film 34 further includes an innermost layer, which is made of SiO₂ and has a thickness of 50.95 nm. The average light transmittance of the above-described yet further alternative embodiment of the light-transmitting element 30 at light wavelengths of 800 nm, 750 nm, 550 nm and 350 nm can be seen from the following

TABLE 11

| Light wavelength (nm) | Average light transmittance % |
|---|---|
| 800 | 95.52 |
| 750 | 95.63 |
| 550 | 96.27 |
| 350 | 97.53 |

It is can be seen that a material and/or a thickness of the substrate 12 can be varied according to a particular requirements. Also, a thickness of the coating films 22, 24, 32, 34 can be varied according to particular requirements.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A light-transmitting element for an imaging system, comprising:
a substrate made of polymethyl methacrylate, the substrate having a first surface and a second surface opposite to the first surface;
and at least one coating film formed on at least one surface of the substrate;
wherein the coating film is selected from the group consisting of a single layer and a plurality of layers, and the coating film comprises a material selected from the group consisting of tantalum pentoxide, magnesium fluoride, silicon oxide, and any mixture or combination thereof.

2. Light-transmitting element as claimed in claim 1, wherein the substrate has a thickness of 0.85 mm, and the coating film is deposited on the first surface of the substrate.

3. The light-transmitting element as claimed in claim 2, wherein the coating film is made of silicon oxide, and has a thickness of 67.22 nm.

4. The light-transmitting element as claimed in claim 2, wherein the coating film is made of magnesium fluoride, and has a thickness of 88.33 nm.

5. The light-transmitting element as claimed in claim 1, wherein the substrate has a thickness of 0.85 mm, and the coating film is formed on the first surface of the substrate and the second surface of the substrate, respectively.

6. The light-transmitting element as claimed in claim 5, wherein the coating film is made of silicon oxide and has a thickness of 59.44 nm.

7. The light-transmitting element as claimed in claim 5, wherein the coating film on the first surface is made of magnesium fluoride and has a thickness of 88.33 nm, and the coating film on the second surface is made of magnesium fluoride and has a thickness of 88.29 nm.

8. The light-transmitting element as claimed in claim 5, wherein the coating film on the first surface is made of magnesium fluoride and has a thickness of 62.67 nm, and the coating film on the second surface is made of magnesium fluoride and has a thickness of 67.52 nm.

9. The light-transmitting element as claimed in claim 5, wherein the coating film on the first surface is made of silicon oxide and has a thickness of 63.65 nm, and the coating film on the second surface is made of magnesium fluoride and has a thickness of 67.52 nm.

10. The light-transmitting element as claimed in claim 5, wherein the coating film on the first surface comprises a first outer layer made of tantalum pentoxide and a first inner layer made of magnesium fluoride, the first outer layer has a thickness of 4.16 nm, and the first inner layer has a thickness of 94.60 nm.

11. The light-transmitting element as claimed in claim 10, wherein the coating film on the second surface comprises a second outer layer made of magnesium fluoride and a second inner layer made of silicon oxide, the second outer layer has a thickness of 77.36 nm, and the second inner layer has a thickness of 83.83 nm.

12. The light-transmitting element as claimed in claim 5, wherein the coating film on the first surface comprises a first outer layer made of silicon oxide, a first inner layer made of tantalum pentoxide, and a first innermost layer made of magnesium fluoride, the first outer layer has a thickness of 51.00 nm, the first inner layer has a thickness of 3.20 nm, and the first innermost layer has a thickness of 96.19 nm.

13. The light-transmitting element as claimed in claim 12, wherein the coating film on the second surface comprises a second outer layer made of magnesium fluoride, a second inner layer made of tantalum pentoxide, and a second innermost layer made of silicon oxide, the second outer layer has a thickness of 97.14 nm, and the second inner layer has a thickness of 3.21 nm, and the second innermost layer has a thickness of 50.95 nm.

14. A method for forming a light-transmitting element, comprising the steps of:
providing a substrate made of polymethyl methacrylate, the substrate having a first surface and a second surface opposite to the first surface;
and depositing at least one coating film on at least one surface of the substrate;
wherein the coating film is selected from the group consisting of a single layer and a plurality of layers, and the coating film comprises a material selected from the group consisting of tantalum pentoxide, magnesium fluoride, silicon oxide, and any mixture or combination thereof.

15. The method according to claim 14, wherein the substrate has a thickness of 0.85 mm, and the coating film is deposited on one of the surfaces of the substrate by electron beam evaporation.

16. The method according to claim 15, wherein the coating film is made of silicon oxide, and has a thickness of 67.22 nm.

17. The method according to claim 15, wherein the coating film is made of magnesium fluoride, and has a thickness of 88.33 nm.

18. The method according to claim 14, wherein the substrate has a thickness of 0.85 mm, and the coating film is deposited on the first surface of the substrate and the second surface of the substrate, respectively.

19. The method according to claim 18, wherein the coating film is made of silicon oxide and has a thickness of 59.44 nm.

20. The method according to claim 18, wherein the coating film on the first surface is made of magnesium fluoride and has a thickness of 88.33 nm, and the coating film on the second surface is made of magnesium fluoride and has a thickness of 88.29 nm.

21. A light-transmitting element, comprising:
a substrate capable of transmitting light therein and allowing passage of said light, said substrate comprising a first surface for accepting said light into said substrate and a second surface for emitting said light out of said substrate;
and at least two coating films formed on said substance and at least one of said at least two coating films formed on said first surface of said substrate, each of said at least two coating films made of material having a refractive index different from others of said at least two coating films.

22. The light-transmitting element as claimed in claim 21, wherein two of said at least two coating films are formed on said first surface and next to each other, and said two of said at least two coating films have respective material with a refractive index different from each other.
